(19) United States
(12) Patent Application Publication
(10) Pub. No.: US 2026/0050076 A1
(43) Pub. Date: Feb. 19, 2026

(54) COMMUNICATION MODULE, OPERATING METHOD OF THE COMMUNICATION MODULE, AND ELECTRONIC DEVICE

(71) Applicant: SAMSUNG ELECTRONICS CO., LTD., Suwon-si (KR)

(72) Inventors: Jaehoon JUNG, Seoul-si (KR); Seongcheol KIM, Seoul-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/066,956

(22) Filed: Feb. 28, 2025

(30) Foreign Application Priority Data
Aug. 16, 2024 (KR) 10-2024-0110010

(51) Int. Cl. G01S 13/46; H04L 27/26

(52) U.S. Cl. CPC G01S 13/46; H04L 27/2636; G01S 2013/462

(57) ABSTRACT

An operating method of a communication module in a communication radar compatible system, may include: transmitting, via a plurality of antennas, a transmission signal to at least one target using; receiving, via a plurality of antennas, an analog reception signal reflected from the at least one target; converting the analog reception signal into a digital reception signal; generating a target distance signal related to a distance to the at least one target based on the digital reception signal; estimating a frequency offset based on the target distance signal; correcting a distance estimation value to the at least one target based on the frequency offset; and outputting the corrected distance estimation value.

### CROSS-REFERENCE TO RELATED APPLICATION

This application is based on and claims priority under 35 U.S.C. § 119 to Korean Patent Application No. 10-2024-0110010, filed on Aug. 16, 2024, in the Korean Intellectual Property Office, the disclosure of which is incorporated by reference herein in its entirety.

### BACKGROUND

The disclosure relates to a communication module configured to improve the accuracy of distance estimation through signal processing on orthogonal frequency division multiplexing (OFDM) signals, an operating method of the communication module, and an electronic device.

A communication radar compatible system may perform both communication and radar functions by using a single signal. For example, the communication radar compatible system may be a system that performs a radar function by transmitting a signal used in communication and then measuring a signal reflected from a target. Among communication radar compatible systems, an OFDM communication radar compatible system is a representative example. Here, OFDM means a digital modulation method using carrier frequencies. In the OFDM communication radar compatible system, an electronic device may estimate the distance, speed, or the like of a target by transmitting an OFDM signal to the target and then processing a signal reflected from the target. In a general radar system (e.g., a frequency-modulated continuous wave (FMCW) radar system, a sampling frequency of a reception signal must be greater than the bandwidth of a baseband signal to sample a radar signal without distortion. However, OFDM signals are signals designed to satisfy a communication standard, and thus an available bandwidth is limited due to design characteristics of signal waves, causing deterioration of radar functions (e.g., a distance estimation function to a target or the like). Accordingly, a method is required to prevent deterioration of radar functions described above in an OFDM-signal-based communication radar compatible system.

### SUMMARY

Example embodiments of the disclosure provide a communication module configured to improve the accuracy of distance estimation through signal processing on orthogonal frequency division multiplexing (OFDM) signals in a communication radar compatible system, an operating method of the communication module, and an electronic device.

Aspects of the disclosure are not limited to those mentioned above, and other aspects will be clearly understood by those skilled in the art from the following description.

According to an example embodiment, an operating method of a communication module in a communication radar compatible system, may include: transmitting, via a plurality of antennas, a transmission signal to at least one target; receiving, via a plurality of antennas, an analog reception signal reflected from the at least one target; converting the analog reception signal into a digital reception signal; generating a target distance signal related to a distance to the at least one target based on the digital reception signal; estimating a frequency offset based on the target distance signal; correcting a distance estimation value to the at least one target based on the frequency offset; and outputting the corrected distance estimation value.

According to an example embodiment, a communication module of a communication radar compatible system, may include: a plurality of antennas configured to transmit a transmission signal to at least one target and receive an analog reception signal reflected from the at least one target; and a signal processing circuit, wherein the signal processing circuit is configured to: sample and convert the analog reception signal into a digital reception signal; generate a target distance signal related to a distance to the at least one target based on the digital reception signal; estimate a frequency offset based on the target distance signal; correct a distance estimation value to the at least one target based on the frequency offset; and output the corrected distance estimation value.

According to an example embodiment, an electronic device of a communication radar compatible system, may include: a communication module; memory storing instructions; at least one processor operatively connected to the communication module and the memory, and configured to execute the instructions, wherein the instructions, when executed by the at least one processor, cause the at least one processor to control the communication module to: transmit a transmission signal to at least one target; receive an analog reception signal reflected from the at least one target and convert the analog reception signal into a digital reception signal; generate a target distance signal related to a distance to the at least one target based on the digital reception signal; estimate a frequency offset based on the target distance signal; correct a distance estimation value to the at least one target based on the frequency offset; and output the corrected distance estimation value.

### BRIEF DESCRIPTION OF THE DRAWINGS

Embodiments of the disclosure will be more clearly understood from the following detailed description taken in conjunction with the accompanying drawings, in which:

FIG. 1 illustrates a block diagram of an electronic device in a communication radar compatible system according to one or more embodiments;

FIG. 2 is a flowchart to describe an operating method of a communication module according to one or more embodiments;

FIG. 3 is a flowchart to describe an operating method of a communication module according to one or more embodiments;

FIG. 4 is a flowchart to describe an operating method of a communication module according to one or more embodiments;

FIG. 5A is a diagram to describe an example of a target discrete Fourier transform (DFT) spectrum according to one or more embodiments;

FIG. 5B is a diagram to describe an example of a target discrete Fourier transform (DFT) spectrum according to one or more embodiments;

FIG. 6A is a diagram to describe a distance estimation operation of a signal processing circuit according to one or more embodiments;

FIG. 6B is a diagram to describe a distance estimation operation of a signal processing circuit according to one or more embodiments;

FIG. 7 is a diagram to describe a correlation between a signal-to-noise ratio (SNR) and a distance estimation error of a signal processing circuit, according to one or more embodiments;

FIG. 8 is a diagram to describe a correlation between a change in distance to another target and a distance estimation error of a signal processing circuit, according to one or more embodiments; and

FIG. 9 is a block diagram of an electronic device according to one or more embodiments.

### DETAILED DESCRIPTION

Example embodiments of the disclosure will now be described more fully with reference to the accompanying drawings. Embodiments of the disclosure are illustrated in the drawings and described in detail, but various embodiments of the disclosure are not limited to a specific form. For example, it will be apparent to those skilled in the art that the embodiments of the disclosure can be variously modified.

In the disclosure, an electronic device may refer to a modem that performs communication and radar functions by using a single signal (e.g., an orthogonal frequency division multiplexing (OFDM) signal).

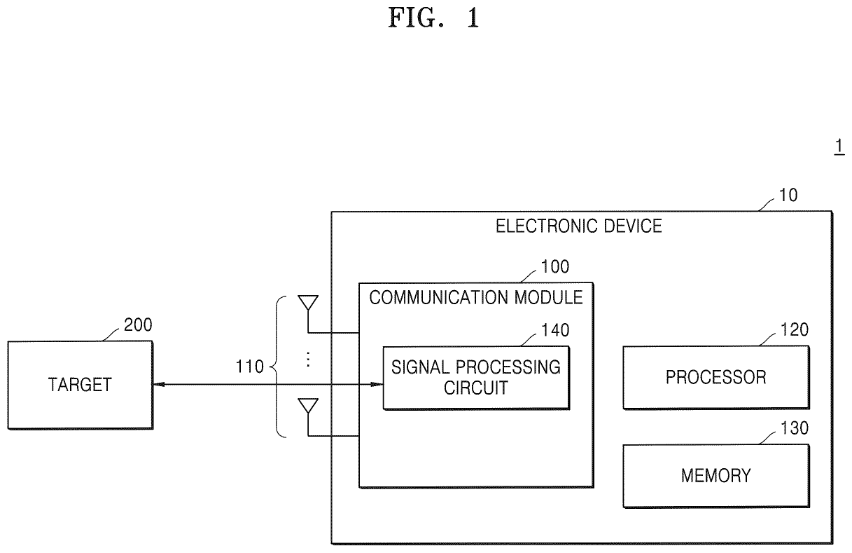

FIG. 1 illustrates a block diagram of an electronic device in a communication radar compatible system according to one or more embodiments.

Referring to FIG. 1, a communication radar compatible system (e.g., an OFDM communication radar compatible system) 1 according to one or more embodiments may include an electronic device 10 and a target 200. In the communication radar compatible system 1, the electronic device 10 may include a signal processing circuit 140 that performs a communication function and a radar function based on OFDM. The target 200 may be an object of which the distance and speed must be measured within the communication radar compatible system 1. The target 200 may be a moving unit (e.g., a vehicle) moving along a road or may be a stationary object. For convenience of explanation, FIG. 1 illustrates one or more embodiments in which a single target 200 exists within the communication radar compatible system 1, but at least one target 200 may exist within the communication radar compatible system 1.

The electronic device 10 may be user equipment, a mobile station (MS), a mobile terminal (MT), a user terminal, a subscribe station (SS), a wireless device, a handheld device, or the like.

The electronic device 10 may support fourth-generation (4G) communication (for example, long-term evolution (LTE), LTE-advanced (LTE-A)), fifth-generation (5G) communication (for example, new radio (NR)), or the like, as specified in the third generation partnership project (3GPP) standard.

The electronic device 10 may, for 4G communication and 5G communication, support a communication protocol based on code division multiple access (CDMA), a communication protocol based on wideband CDMA (WCDMA), a communication protocol based on time division multiple access (TDMA), a communication protocol based on frequency division multiple access (FDMA), a communication protocol based on OFDM, a communication protocol based on cyclic prefix (CP)-OFDM, a communication protocol based on discrete Fourier transform-spread-OFDM (DFT-s-OFDM), a communication protocol based on non-orthogonal multiple access (NOMA), a communication protocol based on generalized frequency division multiplexing (GFDM), or the like.

The electronic device 10 may include a wireless communication module (e.g., a cellular communication module, a near-field wireless communication module, or a global navigation satellite system (GNSS) communication module) or a wired communication module (e.g., a local area network (LAN) communication module or a power line communication module). The electronic device 10 may communicate with an external electronic device via a first network (e.g., a near-field communication network such as Bluetooth, WiFi direct, or infrared data Association (IrDA)) or a second network (e.g., a long-range communication network such as a cellular network, the Internet, or a computer network (e.g., LAN or wide area network (WAN))). Various types of communication modules may be implemented as a single component (e.g., a single chip) or as a plurality of components (e.g., a plurality of chips). The electronic device 10 may include a communication module 100, at least one processor 120, and memory 130.

The communication module (communication interface) 100 may be electrically connected to a plurality of antennas 110 to support the establishment of a communication channel with an external electronic device or the target 200 and the performance of communication through the established communication channel. In other words, the communication module 100 may communicate with an external device or the target 200 by transmitting and receiving radio frequency (RF) signals to and from through the plurality of antennas 110.

The communication module 100 may receive data signals (e.g., data symbols) from the processor 120. The communication module 100 may encode, multiplex, and/or analog-convert the received data signals. The communication module 100 may up-convert the frequency of intermediate-frequency signals or baseband signals output from the processor 120 to transmit the signals to an external device or the target 200 through the plurality of antennas 110 as RF signals. For example, the communication module 100 may communicate with an external device or the target 200, based on OFDM. That is, the communication module 100 may transmit an OFDM transmission signal to the target 200.

The communication module 100 may down-convert RF signals received from an external electronic device or the target 200 to generate intermediate-frequency signals or baseband signals. For example, the communication module 100 may generate baseband signals by down-converting OFDM reception signals (analog) reflected from the target 200. The communication module 100 may transmit the generated baseband signals to a signal processing circuit 140. The communication module 100 (e.g., the signal processing circuit 140) may convert baseband signals into data signals (hereinafter, referred to as digital reception signals) by filtering, decoding, and/or digitizing (e.g., sampling) the baseband signals. The communication module 100 may include the signal processing circuit 140.

The communication module 100 may generate a target distance signal from a digital reception signal by using the signal processing circuit 140. Here, the target distance signal may be a signal for estimating a distance to the target 200. In one or more embodiments, the signal processing circuit 140 of the communication module 100 may estimate a transmission data symbol by applying DFT to a digital reception signal. The signal processing circuit 140 may generate a target distance signal based on a ratio between a transmission data symbol and a reception data symbol.

The communication module 100 may estimate a frequency offset based on a target distance signal by using the signal processing circuit 140.

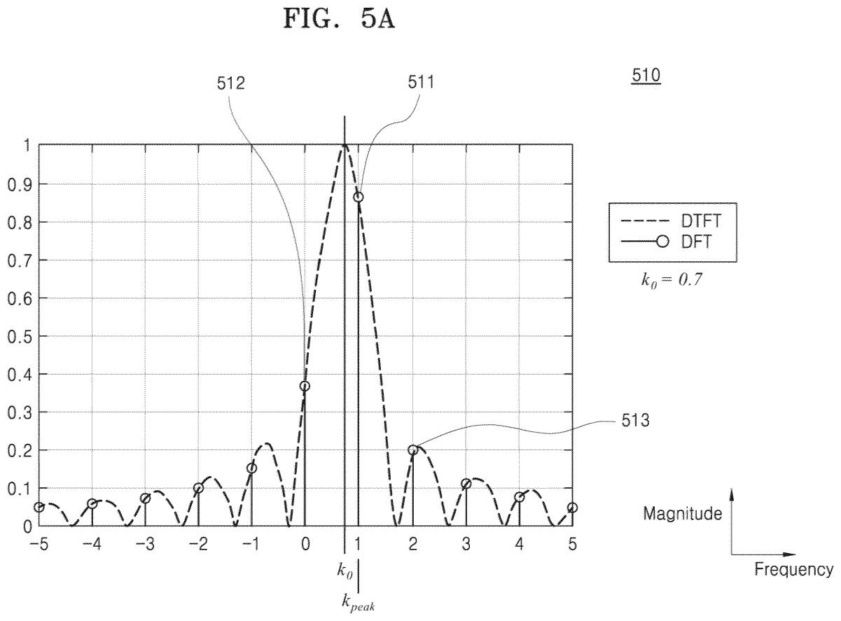

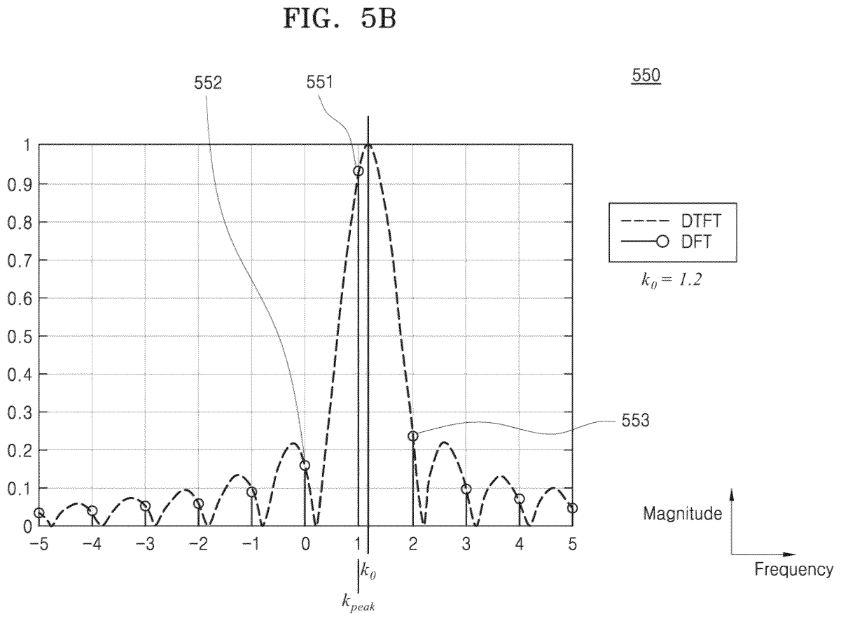

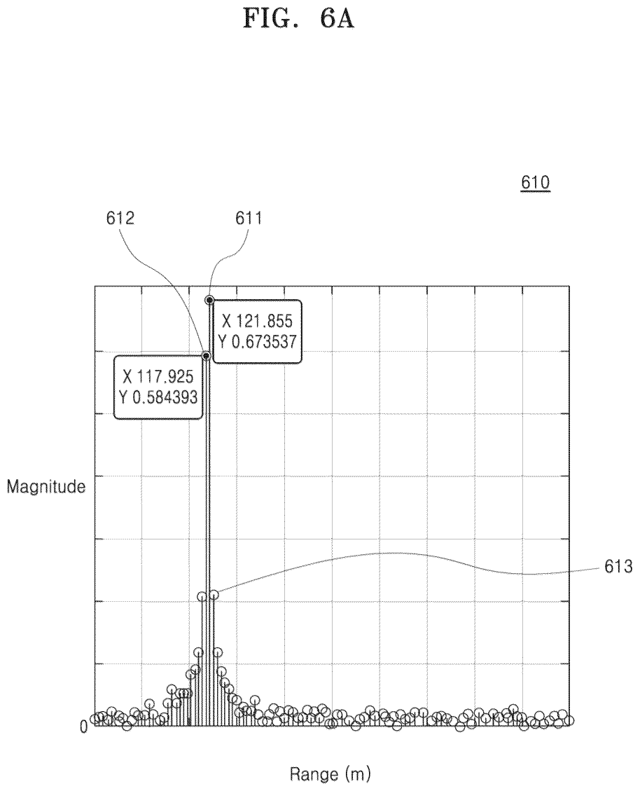

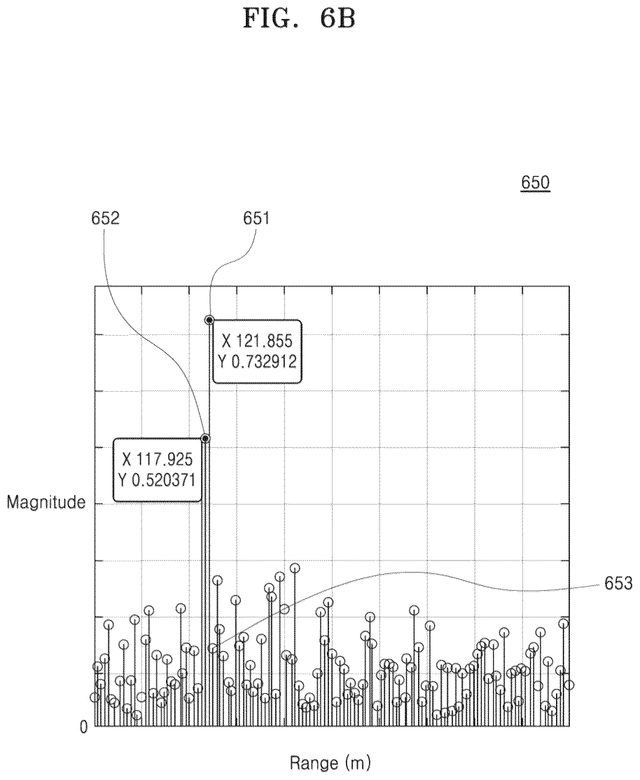

In one or more embodiments, the signal processing circuit 140 may generate a target DFT spectrum (refer to FIGS. 5A, 5B, 6A, and 6B) by applying DFT to a target distance signal. The signal processing circuit 140 may estimate a peak frequency in the target DFT spectrum. The signal processing circuit 140 may estimate a frequency offset by using a ratio between a magnitude value of a DFT sample of an estimated peak frequency and a magnitude value of the DFT sample of a surrounding frequency. Here, the surrounding frequency may mean a frequency sampled before an estimated peak frequency or a frequency sampled right after the estimated peak frequency among a plurality of frequencies that are continuously sampled (i.e. a nearby frequency).

In one or more embodiments, the signal processing circuit 140 may perform the following operations to estimate a frequency offset by using a ratio between a magnitude value of a DFT sample of an estimated peak frequency and a magnitude value of the DFR sample of a surrounding frequency: the signal processing circuit 140 may identify DFT samples of surrounding frequencies (e.g., a first DFT sample and a second DFT sample), based on the estimated peak frequency in the target DFT spectrum. The signal processing circuit 140 may compare a magnitude value of the first DFT sample with a magnitude value of the second DFT sample to estimate a frequency offset based on the comparison result. Here, the first DFT sample may mean a DFT sample of a sampling frequency before the estimated peak frequency among the plurality of frequencies that are continuously sampled, and the second DFT sample may mean a DFT sample of a sampling frequency after the estimated peak frequency among the plurality of frequencies that are continuously sampled.

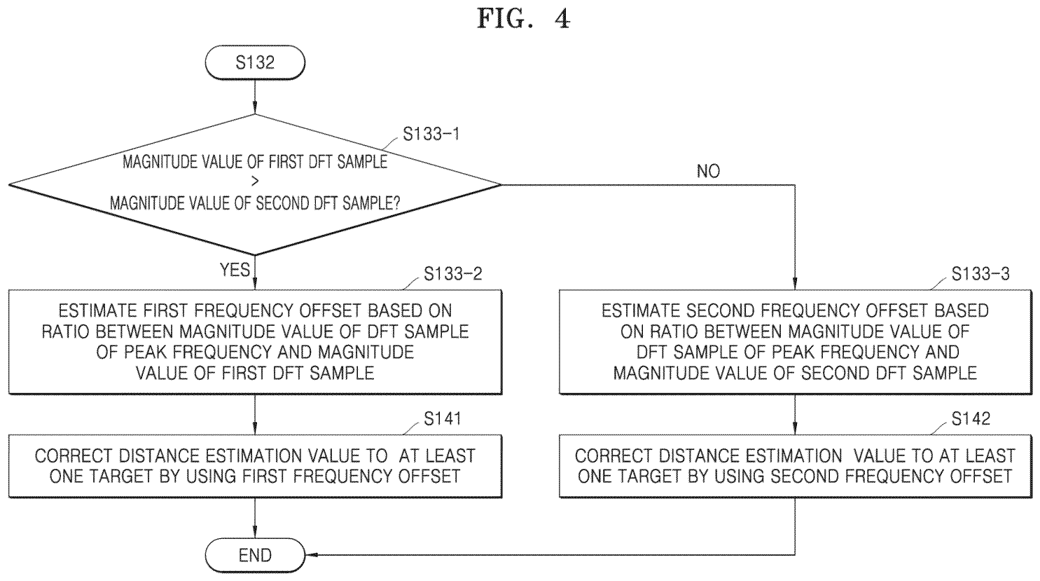

In one or more embodiments, the signal processing circuit 140 may perform the following operations to estimate a frequency offset based on a comparison result between the magnitude value of the first DFT sample and the magnitude value of the second DFT sample: when the magnitude value of the first DFT sample is greater than the magnitude value of the second DFT sample, the signal processing circuit 140 may estimate a frequency offset based on a ratio between a magnitude value of the DFT sample of the estimated peak frequency and the magnitude value of the first DFT sample. For example, the signal processing circuit 140 may estimate the frequency offset based on Equation 8 (refer to FIG. 4) to be described below. When the magnitude value of the first DFT sample is less than the magnitude value of the second DFT sample, the signal processing circuit 140 may estimate a frequency offset based on a ratio between the magnitude value of the DFT sample of the estimated peak frequency and the magnitude value of the second DFT sample. For example, the signal processing circuit 140 may estimate the frequency offset based on Equation 13 (refer to FIG. 4) to be described below.

The communication module 100 may correct a distance estimation value to the target 200, based on a frequency offset by using the signal processing circuit 140, and output the corrected distance estimation value.

In one or more embodiments, the signal processing circuit 140 may perform the following operations to correct a distance estimation value to the target 200, based on a frequency offset. When the magnitude value of the first DFT sample is greater than the magnitude value of the second DFT sample, the signal processing circuit 140 may correct a distance estimation value to the target 200 by using a frequency offset estimated based on Equation 11 (refer to FIG. 4) to be described below. When the magnitude value of the first DFT sample is less than the magnitude value of the second DFT sample, the signal processing circuit 140 may correct a distance estimation value to the target 200 by using a frequency offset estimated based on Equation 14 (refer to FIG. 4) to be described below.

The (at least one) processor 120 may include one or more of a central processing unit (CPU), a graphics processing unit (GPU), and a neural processing unit (NPU) as internal operation processing units, and may execute one or more instructions (software). The processor 120 may be implemented as a logic block implemented through logic synthesis, a software block executed by a processor, or a combination thereof. The processor 120 may be a procedure as a set of a plurality of instructions executed by a processor, and the set of the plurality of instructions may be stored in the memory 130 accessible by the processor 120.

The processor 120 may control other components (e.g., hardware or software components) included in the electronic device 10 by executing one or more instructions, and may also perform various data processing or computations in the electronic device 10. For example, the processor 120 may load instructions or data received from another component into volatile memory, process the instructions or data stored in the volatile memory, and store result data in non-volatile memory, as at least a portion of data processing or computations. As another example, the processor 120 may include a main processor (e.g., a CPU or an application processor) and an auxiliary processor (e.g., a GPU, an image signal processor, a sensor hub processor, or a communication processor) that may operate independently or together with the main processor. The auxiliary processor may be configured to use less power than the main processor or to be specialized in specific function. The auxiliary processor may be implemented separately from the main processor or as a portion of the main processor. In one or more embodiments, the processor 120 may control other components (e.g., hardware or software components) included in the communication module 100 (or the signal processing circuit 140) by executing one or more instructions to perform a correction operation of a distance estimation value in the communication module 100 (or the signal processing circuit 140) described above.

The memory 130 may store one or more instructions. In addition, the memory 130 may store data used by at least one component (e.g., the processor 120) of the communication module 100 (or the signal processing circuit 140). The data may include one or more instructions (software) and input data or output data for commands associated with the instructions. The memory 130 may include volatile memory or non-volatile memory. A program may be stored in the memory 130 as software, and may include, for example, an operating system, middleware, or an application.

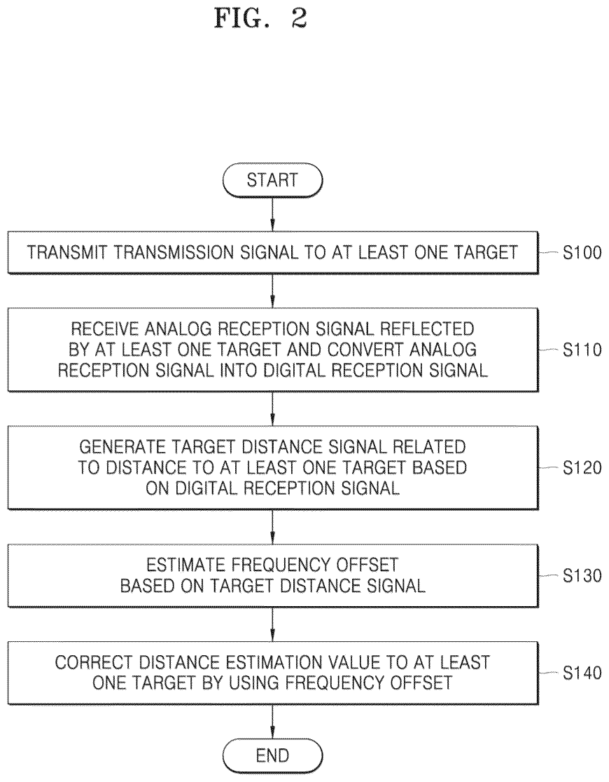

As described above, the electronic device 10 including the communication module 100 (or the signal processing circuit 140) according to one or more embodiments may additionally process reception signals reflected from the target 200 to improve distance estimation performance (e.g., resolution) without adding/changing a separate hardware configuration. According to one or more embodiments, a method of improving distance estimation performance (e.g., resolution) is described in detail with reference to FIGS. 2 to 4.

In addition, according to the communication module 100 according to various embodiments, an operating method of the communication module 100, and the electronic device 10, the distance estimation performance (e.g., resolution) to a target in a communication radar compatible system may be improved through a relatively low computational load.

FIG. 2 is a flowchart to describe an operating method of a communication module according to one or more embodiments.

Referring to FIG. 2, in a communication radar compatible system, a method of correcting a distance estimation value through OFDM-based signal processing by using the signal processing circuit 140 of the communication module 100 may include operations S100 to S140. In the description of FIG. 2, descriptions that are already given with reference to FIG. 1 are omitted.

The communication module 100 of FIG. 2 may correspond to the communication module 100 of FIG. 1, the signal processing circuit 140 of FIG. 2 may correspond to the signal processing circuit 140 of FIG. 1, and at least one target of FIG. 2 may correspond to the target 200 of FIG. 1.

In operation S100, the communication module 100 may transmit an OFDM transmission signal to at least one target. For example, the OFDM transmission signal transmitted by the communication module 100 may be expressed as shown in Equation 1.

$${s}_{b} ( t ) = {\sum }_{k = 0}^{K - 1} {c}_{k} {e}^{j 2 π ( {f}_{0} + k Δ f ) t} rect ( \frac{t + {T}_{cp}}{{T}_{sym}} ) \qquad [ Equation 1 ]$$

Here, s_{b}(t) may mean the OFDM transmission signal transmitted by the communication module 100, K may mean the number of subcarriers, cₖ may mean a data symbol of a k-th subcarrier, f₀ may mean a carrier frequency, Δf may mean a distance between subcarriers, T_{sym}=T+T_{cp} may mean a signal length including a CP, T may mean an original signal length, and T_{cp} may mean the length of the CP.

In operation S110, the communication module 100 may receive an analog reception signal reflected from the at least one target and convert the received analog reception signal into a digital reception signal. For example, the OFDM transmission signal (s_{b}(t)) transmitted in operation S100 may be reflected from the at least one target (e.g., 200 of FIG. 1) and received as an OFDM reception signal (analog) in the communication module 100. The communication module 100 may down-convert the OFDM reception signal (analog) to baseband. The communication module 100 (e.g., the signal processing circuit 140) may sample the OFDM reception signal (analog) of the baseband to convert the OFDM reception signal (analog) into an OFDM reception signal (digital). At this time, the OFDM reception signal (digital) may be expressed as shown in Equation 2.

$${r}_{b} [ m ] = {\sum }_{k = 0}^{K - 1} {c}_{k} exp \{ - j 2 π ( {f}_{0} + k Δ f ) τ \} exp ( i 2 π \frac{mk}{K} ) \qquad [ Equation 2 ]$$

Here, r_{b}[m] may mean the OFDM reception signal (digital) sampled by the signal processing circuit 140.

In operation S120, the communication module 100 may generate a target distance signal related to a distance to the at least one target based on the digital reception signal. The signal processing circuit 140 of the communication module 100 may estimate a transmission data symbol by applying DFT to the digital reception signal. At this time, the estimated transmission data symbol may be expressed as shown in Equation 3.

$${\hat{c}}_{k} = {\sum }_{m = 0}^{K - 1} {r}_{b} [ m ] exp ( - j 2 π \frac{m k}{K} ) = {c}_{k} exp \{ - j 2 π ( {f}_{0} + k Δ f ) τ \} \qquad [ Equation 3 ]$$

Here, ĉₖ may mean a transmission data symbol estimated by the signal processing circuit 140, and cₖ may mean a transmission data symbol actually transmitted by the communication module 100.

The signal processing circuit 140 of the communication module 100 may generate a target distance signal based on a ratio between an estimated transmission data symbol and an actual transmission data symbol. For example, the estimated transmission data symbol (ĉₖ) may be a form in which the actual transmission data symbol (ĉₖ) is modulated by a propagation time of the k-th subcarrier. Accordingly, a transfer function for a ratio between the estimated transmission data symbol and the actual transmission data symbol may be expressed as shown in Equation 4.

$$H = [ \begin{matrix}{\hat{c}}_{0} / {c}_{0} \\ {\hat{c}}_{1} / {c}_{1} \\ ⋮ \\ {\hat{c}}_{K - 1} / {c}_{K - 1}\end{matrix} ] = [ \begin{matrix}exp ( - j 2 π {f}_{0} τ ) \\ exp ( - j 2 π ( {f}_{0} + Δ f ) τ ) \\ ⋮ \\ exp ( - j 2 π ( {f}_{0} + ( K - 1 ) Δ f ) τ )\end{matrix} ] \qquad [ Equation 4 ]$$

Here, H may mean a transfer function for the estimated transmission data symbol (ĉₖ) and the actual transmission data symbol (ĉₖ) T may mean a time required for an OFDM transmission signal to be reflected by the at least one target and received again by the communication module 100 (e.g., a round trip time from the communication module 100 to the at least one target).

The signal processing circuit 140 may generate a target distance signal based on the transfer function (H) (that is, a transfer function for a ratio between the estimated transmission data symbol (ĉₖ) and the actual transmission data symbol (ĉₖ)). At this time, the target distance signal may be expressed as shown in Equation 5.

$$h [ n ] = exp ( - j 2 π ( {f}_{0} + ( n - 1 ) Δ f ) τ ) \qquad [ Equation 5 ]$$

Here, h[n] may mean a target distance signal, and h[n] may mean a complex exponential signal.

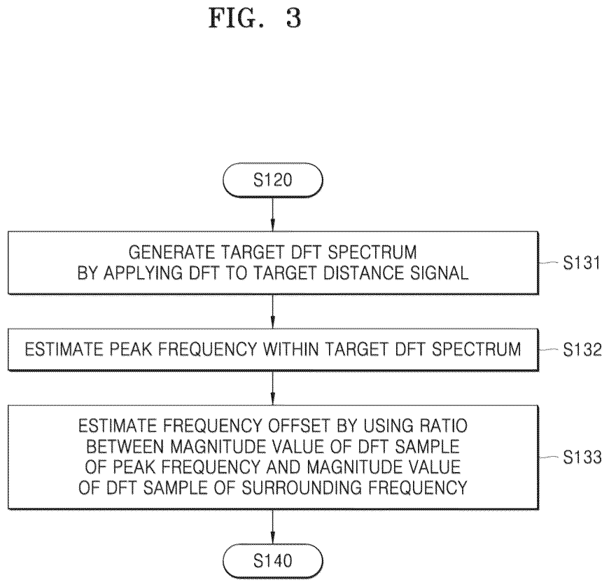

In operation S130, the communication module 100 may estimate a frequency offset based on the target distance signal. A detailed description thereof is described below with reference to FIGS. 3 and 4.

In operation S140, the communication module 100 may correct a distance estimation value to the at least one target by using the frequency offset. For example, the signal processing circuit 140 of the communication module 100 may correct the distance estimation value by reflecting the frequency offset estimated in operation S130 into a computation of estimating a distance to the at least one target. A detailed description thereof is described below with reference to FIG. 4.

As described above, the communication module 100 according to one or more embodiments performs signal processing on OFDM signals by using the signal processing circuit 140, thereby improving the distance estimation performance in the communication radar compatible system.

In addition, as the communication module 100 according to one or more embodiments improves the distance estimation performance based on the signal processing of the signal processing circuit 140, addition of a separate hardware configuration or high computational load is not required.

FIG. 3 is a flowchart to describe an operating method of a communication module according to one or more embodiments.

Referring to FIG. 3, an operation of estimating a frequency offset by the communication module 100 (e.g., the signal processing circuit 140) (operation S130 of FIG. 2) may include operations S131 to S133. In the description of FIG. 3, descriptions that are already given with reference to FIGS. 1 and 2 are omitted.

A communication module 100 of FIG. 3 may correspond to the communication module 100 of FIG. 1, a signal processing circuit 140 of FIG. 3 may correspond to the signal processing circuit 140 of FIG. 1, and at least one target of FIG. 3 may correspond to the target 200 of FIG. 1.

In operation S131, the communication module 100 may generate a target DFT spectrum by applying DFT to a target distance signal. For example, the signal processing circuit 140 of the communication module 100 may generate the target DFT spectrum by applying DFT to the target distance signal (e.g. h[n]) to estimate a frequency component of the target distance signal (e.g. h[n]) generated in operation S120 of FIG. 2 (that is, to estimate a round trip time (τ) to at least one target and/or a distance to the at least one target). The signal processing circuit 140 may estimate a frequency offset based on the target DFT spectrum. At this time, the target DFT spectrum may be expressed as shown in Equation 6.

$$H [ k ] = {\sum }_{n = 0}^{N - 1} h [ n ] exp ( - j \frac{2 π}{N} kn ) \qquad [ Equation 6 ]$$

Here, H[k] may mean a target DFT spectrum generated by applying DFT to a target distance signal (e.g. h[n]).

In operation S132, the communication module 100 may estimate a peak frequency in the target DFT spectrum. The signal processing circuit 140 of the communication module 100 may estimate a peak frequency in the target DFT spectrum, based on Equation 7.

$${k}_{peak} = {max}_{k} H [ k ] \qquad [ Equation 7 ]$$

Here, kₚₑₐₖ may mean a peak frequency estimated by the signal processing circuit 140. For example, the signal processing circuit 140 may estimate a frequency having the largest magnitude of a DFT sample value within the target DFT spectrum as a peak frequency (kₚₑₐₖ) (hereinafter, referred to as an estimated peak frequency).

In operation S133, the communication module 100 may estimate a frequency offset by using a ratio between a magnitude value of a DFT sample of an estimated peak frequency and a magnitude value of a DFT sample of a surrounding frequency. A detailed description thereof is described below with reference to FIG. 4. In a communication radar compatible system based on OFDM, estimating a distance to at least one target by the communication module 100 may correspond to estimating a frequency (e.g., a peak frequency) of a target distance signal (e.g., a complex exponential signal).

FIG. 4 is a flowchart to describe an operating method of a communication module according to one or more embodiments.

In detail, FIG. 4 is a diagram to describe detailed operations (e.g., operations S133-1 to S133-3) of operation S133 of FIG. 3 and detailed operations (e.g., operations S141 and S142) of operation S140 of FIG. 1 linked to operation S133.

Referring to FIG. 4, an operation (operation S133 of FIG. 3) of estimating a frequency offset by the communication module 100 (e.g., the signal processing circuit 140) and an operation (operation S140 of FIG. 2) of correcting a distance estimation value based on the frequency offset may include operations S133-1 to S142. In the description of FIG. 4, descriptions that are already given with reference to FIGS. 1 and 3 are omitted.

A communication module 100 of FIG. 4 may correspond to the communication module 100 of FIG. 1, a signal processing circuit 140 of FIG. 4 may correspond to the signal processing circuit 140 of FIG. 1, and at least one target of FIG. 4 may correspond to the target 200 of FIG. 1.

In operation S133-1, the communication module 100 may identify whether a magnitude value of a first DFT sample is greater than a magnitude value of a second DFT sample by comparing the magnitude value of the first DFT sample with the magnitude value of the second DFT sample. For example, when the magnitude value of the first DFT sample is greater than the magnitude value of the second DFT sample, the signal processing circuit 140 of the communication module 100 may perform operation S133-2. As another example, when the magnitude value of the first DFT sample is less than the magnitude value of the second DFT sample, the signal processing circuit 140 of the communication module 100 may perform operation S133-3. At this time, the first DFT sample may mean a DFT sample of a frequency before the estimated peak frequency (refer to operation S132) among a plurality of frequencies that are continuously sampled, and the second DFT sample may mean a DFT sample of a frequency after the estimated peak frequency among the plurality of frequencies that are continuously sampled.

In operation S133-2, when the magnitude value of the first DFT sample is greater than a magnitude value of the second DFT sample, the communication module 100 may estimate a first frequency offset based on a ratio between a magnitude value of a DFT sample of the estimated peak frequency and the magnitude value of the first DFT sample. For example, the signal processing circuit 140 of the communication module 100 may estimate the first frequency offset based on Equation 8.

$$[ Equation 8 ]$$

$$Γ\_ 1 = \frac{\vert F ( {k}_{0} + α ) \vert}{\vert F ( {k}_{0} + α + 1 ) \vert} = \frac{sin ( π α ) / sin ( π α / N )}{sin ( π ( α + 1 ) ) / sin ( π ( α + 1 ) / N )} \approx - ( 1 + \frac{1}{α\_ 1} )$$

Here, Γ_1 may mean a ratio between a magnitude value of a DFT sample of an estimated peak frequency and the magnitude value of the first DFT sample, k₀ may mean an actual peak frequency in a time domain signal (f[n]) of a target distance signal, and α_1 may mean the first frequency offset. The time domain signal (f[n]) of the target distance signal may be expressed as shown in Equation 9.

$$f [ n ] = {e}^{j {w}_{0} n} ( n = 0 , 1 , … , N - 1 ) \qquad [ Equation 9 ]$$

Here, w₀=(2π/N)k₀. At this time, when is not an integer multiple of 2π/N. (that is, when k₀ is not an integer), an estimation value of the frequency offset may include an error.

The signal processing circuit 140 may calculate each of the ‘magnitude value of a DFT sample of an estimated peak frequency of Equation 8 and the magnitude value of the first DFT sample’ based on Equation 10. [Equation 10]

$$\vert F [ k ] \vert = \frac{sin ( π ( k - {k}_{0} ) )}{sin ( π ( k - {k}_{0} ) / N )} ( k = 0 , 1 , … , N - 1 ) \qquad [ Equation 10 ]$$

Here, |F[k]| may mean a magnitude value of a DFT sample of a frequency k in the target DFT spectrum.

In operation S141, the communication module 100 may correct a distance estimation value to at least one target by using the first frequency offset. For example, the signal processing circuit 140 of the communication module 100 may correct the distance estimation value to the at least one target by using the first frequency offset based on Equation 11.

$$\hat{R} = ( {k}_{peak} + α\_ 1 ) \times \frac{c}{2 K Δ f} \qquad [ Equation 11 ]$$

Here, \hat{R} may mean a distance estimation value to at least one target, α_1 may mean a first frequency offset,

$$\frac{c}{2 K Δ f}$$

may mean the distance resolution in an OFDM communication radar compatible system (where C is the speed light constant), K may mean the total number of subcarriers, and Δf may mean a distance between subcarriers. Equation 11 may be expressed as shown in Equation 12 based on a ratio (Γ_1) between the magnitude value of the DFT sample of the estimated peak frequency and the magnitude value of the first DFT sample.

$$\hat{R} = ( {k}_{peak} - \frac{1}{1 + Γ\_ 1} ) \times \frac{c}{2 K Δ f} \qquad [ Equation 12 ]$$

Here,

$$- \frac{1}{1 + Γ\_ 1}$$

may mean the first frequency offset (α_1).

In operation S133-3, when the magnitude value of the first DFT sample is less than the magnitude value of the second DFT sample, the communication module 100 may estimate a second frequency offset based on a ratio between the magnitude value of the DFT sample of the estimated peak frequency and the magnitude value of the second DFT sample. For example, the signal processing circuit 140 of the communication module 100 may estimate a second frequency offset based on Equation 13.

$$[ Equation 13 ]$$

$$Γ\_ 2 = \frac{\vert F ( {k}_{0} + α ) \vert}{\vert F ( {k}_{0} + α - 1 ) \vert} = \frac{sin ( π α ) / sin ( π α / N )}{sin ( π ( α + 1 ) ) / sin ( π ( α - 1 ) / N )} \approx - ( 1 - \frac{1}{α\_ 2} )$$

Here, Γ_2 may mean a ratio between a magnitude value of a DFT sample of an estimated peak frequency and the magnitude value of the second DFT sample, k₀ may mean an actual peak frequency in a time domain signal (f[n]) of a target distance signal, and α_2 may mean a second frequency offset. The time domain signal (f[n]) of the target distance signal may be expressed as shown in Equation 9 as described above. The signal processing circuit 140 may calculate each of the ‘magnitude value of a DFT sample of an estimated peak frequency of Equation 13 and the magnitude value of the second DFT sample’ based on Equation 10 as described above.

In operation S142, the communication module 100 may correct a distance estimation value to at least one target by using the second frequency offset. For example, the signal processing circuit 140 of the communication module 100 may correct the distance estimation value to the at least one target by using the second frequency offset based on Equation 14.

$$\hat{R} = ( {k}_{peak} + {α}_{-} 2 ) \times \frac{C}{2 K Δ f} \qquad [ Equation 14 ]$$

Here, \hat{R} may mean a distance estimation value to at least one target, α_2 may mean a second frequency offset,

$$\frac{c}{2 K Δ f}$$

may mean the distance resolution in an OFDM communication radar compatible system (where C is the speed of light constant), K may mean the total number of subcarriers, and Δf may mean a distance between subcarriers. Equation 14 may be expressed as shown in Equation 15 based on a ratio (Γ_2) between the magnitude value of the DFT sample of the estimated peak frequency and the magnitude value of the second DFT sample.

$$\hat{R} = ( {k}_{peak} + \frac{1}{1 + Γ\_ 2} ) \times \frac{c}{2 K Δ f} \qquad [ Equation 15 ]$$

Here,

$$+ \frac{1}{1 + Γ\_ 2}$$

may mean the second frequency offset (α_2).

FIGS. 5A and 5B are diagrams to describe an example of a target DFT spectrum according to one or more embodiments.

In detail, FIGS. 5A and 5B illustrate an example of a target DFT spectrum generated by the signal processing circuit 140. In FIGS. 5A and 5B, the dashed line graph is a graph in which a discrete-time Fourier transform (DTFT) is applied to a target distance signal, and the point-solid line graph is a graph in which DFT is applied to the target distance signal. As shown in FIGS. 5A and 5B, when an actual peak frequency (k₀) is not an integer, an error may occur in frequency offset estimation in some cases.

Referring to FIG. 5A, a first target DFT spectrum 510 illustrates a target DFT spectrum when the actual peak frequency (k₀) is 0.7.

The signal processing circuit 140 may estimate a peak frequency based on Equation 7 as described above. In FIG. 5A, it may be confirmed that an estimated peak frequency (kₚₑₐₖ) estimated by the signal processing circuit 140 is ‘1.’

The signal processing circuit 140 may identify FDT samples (e.g., a first DFT sample 512 and a second DFT sample 513) of surrounding frequencies, based on the estimated peak frequency (kₚₑₐₖ) in the first target DFT spectrum 510. The signal processing circuit 140 may compare a magnitude value of the first DFT sample 512 with a magnitude value of the second DFT sample 513 to estimate a frequency offset based on the comparison result. Here, the first DFT sample 512 may mean a DFT sample of a frequency (e.g., a frequency located on the left side of the estimated peak frequency (kₚₑₐₖ)) before the estimated peak frequency (kₚₑₐₖ) among a plurality of frequencies that are continuously sampled, and the second DFT sample 513 may mean a DFT sample of a frequency (e.g., a frequency located on the right side of the estimated peak frequency (kₚₑₐₖ)) after the estimated peak frequency (kₚₑₐₖ) among the plurality of frequencies that are continuously sampled.

In FIG. 5A, as it is confirmed that the magnitude value of the first DFT sample 512 is greater than the magnitude value of the second DFT sample 513, the signal processing circuit 140 may estimate a first frequency offset based on a ratio between the magnitude value of a DFT sample 511 of the estimated peak frequency (kₚₑₐₖ) and the magnitude value of the first DFT sample 512. For example, the signal processing circuit 140 may estimate the first frequency offset based on Equation 8 (refer to FIG. 4).

As shown in FIG. 5A, when the magnitude value of the first DFT sample is greater than the magnitude value of the second DFT sample, the signal processing circuit 140 may correct a distance estimation value to the target 200 by using the estimated first frequency offset. For example, the signal processing circuit 140 may correct the distance estimation value to the target 200 based on Equation 11 (or Equation 12) (refer to FIG. 4).

Referring to FIG. 5B, a second target DFT spectrum 550 illustrates a target DFT spectrum when the actual peak frequency (k₀) is ‘1.2.’

The signal processing circuit 140 may estimate a peak frequency based on Equation 7 as described above. In FIG. 5B, it is confirmed that an estimated peak frequency (kₚₑₐₖ) estimated by the signal processing circuit 140 is ‘1.’

The signal processing circuit 140 may identify DFT samples (for example, a first DFT sample 552 and a second DFT sample 553) of surrounding frequencies based on the estimated peak frequency (kₚₑₐₖ) in the second target DFT spectrum 550. The signal processing circuit 140 may compare a magnitude value of the first DFT sample 552 with a magnitude value of the second DFT sample 553 to estimate a frequency offset based on the comparison result. Here, the first DFT sample 552 may mean a DFT sample of a frequency (e.g., a frequency located on the left side of the estimated peak frequency (kₚₑₐₖ)) before (lower than) the estimated peak frequency (kₚₑₐₖ) among a plurality of frequencies that are continuously sampled, and the second DFT sample 553 may mean a DFT sample of a frequency (e.g., a frequency located on the right side of the estimated peak frequency (kₚₑₐₖ)) after (higher than) the estimated peak frequency (kₚₑₐₖ) among the plurality of frequencies that are continuously sampled.

In FIG. 5B, as it is confirmed that the magnitude value of the first DFT sample 552 is less than the magnitude value of the second DFT sample 553, the signal processing circuit 140 may estimate a second frequency offset based on a ratio between the magnitude value of a DFT sample 551 of the estimated peak frequency (kₚₑₐₖ) and the magnitude value of the second DFT sample 553. For example, the signal processing circuit 140 may estimate the second frequency offset based on Equation 13 (refer to FIG. 4).

As shown in FIG. 5B, when the magnitude value of the first DFT sample is less than the magnitude value of the second DFT sample, the signal processing circuit 140 may correct a distance estimation value to the target 200 by using the estimated second frequency offset. For example, the signal processing circuit 140 may correct the distance estimation value to the target 200, based on Equation 14 (or Equation 15) (refer to FIG. 4).

FIGS. 6A and 6B are diagrams to describe a distance estimation operation of a signal processing circuit according to one or more embodiments.

In detail, FIGS. 6A and 6B illustrate an example of a target DFT spectrum generated by the signal processing circuit 140. In FIGS. 6A and 6B, an actual distance to a target is 120 m, and a theoretical resolution of an OFDM communication radar compatible system is assumed to be 3.9308 m. In addition, when generating a first 610 and a second target DFT spectrums 650 of FIGS. 6A and 6B, it is assumed that a carrier frequency is 3.5 GHz, a distance between subcarriers is 30 MHz, the number of subcarriers is 1,272, a bandwidth is 38.16 MHz, a signal length is 33.3 μs, and a length of the CP is 2.3 μs. However, the settings of the resolution and the parameters of a target DFT spectrum (e.g., a carrier frequency, a distance between subcarriers, or the like) of the OFDM communication radar compatible system according to one or more embodiments are not limited thereto.

Referring to FIG. 6A, a first target DFT spectrum 610 illustrates a target DFT spectrum for a target distance signal when a signal-to-noise ratio (SNR) is ‘10 dB.’ For example, in the first target DFT spectrum 610, it may be confirmed that a magnitude value of a DFT sample 611 of an estimated peak frequency is 0.673537. In the first target DFT spectrum 610, it may be confirmed that a magnitude value of a first DFT sample 612 is 0.584393. In addition, in the first target DFT spectrum 610, it may be confirmed that the magnitude value of the first DFT sample 612 is greater than a magnitude value of a second DFT sample 613.

Accordingly, when the magnitude value of the first DFT sample 612 is greater than the magnitude value of the second DFT sample 613, the signal processing circuit 140 according to one or more embodiments may estimate a frequency offset based on Equation 8. For example, the signal processing circuit 140 may calculate a ratio (e.g., 1.1048) between the magnitude value of the DFT sample 611 of the estimated peak frequency and the magnitude value of the first DFT sample 612, and may calculate a frequency offset (e.g., 0.4751) based on the ratio.

When the magnitude value of the first DFT sample 612 is greater than the magnitude value of the second DFT sample 613, the signal processing circuit 140 may correct a distance estimation value based on Equation 11 (or Equation 12). For example, the signal processing circuit 140 may calculate the final distance estimation value to a target as 119.9878 m by correcting the distance estimation value (e.g., 121.855 m) by using the frequency offset (e.g., 0.4751). At this time, it may be confirmed that the final distance estimation value (119.9878 m) calculated by the signal processing circuit 140 is closer to an actual distance (120 m) to the target than the previous distance estimation value (121.855 m). Accordingly, it may be confirmed that the distance estimation performance (e.g., resolution) of a communication radar compatible system (e.g., the communication module 100) is improved through correction of a distance estimation value based on signal processing of the signal processing circuit 140 according to one or more embodiments.

Referring to FIG. 6B, the second target DFT spectrum 650 illustrates a target DFT spectrum for a target distance signal when an SNR is ‘−10 dB.’ For example, in the second target DFT spectrum 650, it may be confirmed that a magnitude value of a DFT sample 651 of an estimated peak frequency is 0.732912. In the second target DFT spectrum 650, it may be confirmed that a magnitude value of a first DFT sample 652 is 0.520371. In addition, in the second target DFT spectrum 650, it may be confirmed that the magnitude value of the first DFT sample 652 is greater than a magnitude value of a second DFT sample 653.

Accordingly, when the magnitude value of the first DFT sample 652 is greater than the magnitude value of the second DFT sample 653, the signal processing circuit 140 according to one or more embodiments may estimate a frequency offset based on Equation 8. For example, the signal processing circuit 140 may calculate a ratio (e.g., 1.4084) between the magnitude value of the DFT sample 651 of the estimated peak frequency and the magnitude value of the first DFT sample 652, and may calculate a frequency offset (e.g., 0.4152) based on the ratio.

When the magnitude value of the first DFT sample 652 is greater than the magnitude value of the second DFT sample 653, the signal processing circuit 140 may correct a distance estimation value based on Equation 14 (or Equation 15). For example, the signal processing circuit 140 may calculate the final distance estimation value to a target as 120.223 m by correcting the distance estimation value (e.g., 121.855 m) by using the frequency offset (e.g., 0.4152). At this time, it may be confirmed that the final distance estimation value (120.223 m) calculated by the signal processing circuit 140 is closer to the actual distance (120 m) to the target than the previous distance estimation value (e.g., 121.855 m). Accordingly, it may be confirmed that the distance estimation performance (e.g., resolution) of a communication radar compatible system (e.g., the communication module 100) is improved through correction of a distance estimation value based on signal processing of the signal processing circuit 140 according to one or more embodiments.

As described above, the improvement effect on the distance estimation performance (e.g., resolution) by the communication module 100 (e.g., the signal processing circuit 140) according to one or more embodiments may be confirmed in both communication environments having different SNRs (e.g., 10 dB and −10 dB).

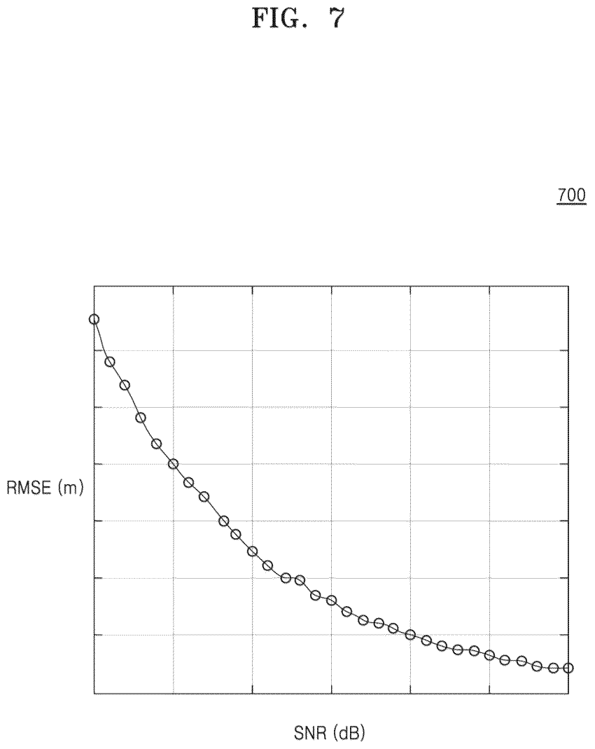

FIG. 7 is a diagram to describe a correlation between an SNR and a distance estimation error of a signal processing circuit, according to one or more embodiments.

The horizontal axis of a graph 700 of FIG. 7 may represent an SNR (dB), and the vertical axis of the graph 700 of FIG. 7 may represent a root mean square error (RMSE) of a distance estimation value estimated by the signal processing circuit 140. When observing the RMSE according to changes in SNR in FIG. 7, it is assumed that a distance to a target is set to a random value within a predetermined range (e.g., about 110 m to about 130 m).

Referring to FIG. 7, the graph 700 is a graph in which the RMSE of a distance estimation value to a target is observed and recorded according to a change in SNR by 1 dB intervals within the predetermined SNR range (e.g., about −10 dB to about 20 dB). Accordingly, a change in distance estimation value according to a change in SNR (that is a correlation between the SNR and an error of the distance estimation value of the signal processing circuit) may be confirmed.

In the graph 700, it may be confirmed that the RMSE of the distance estimation value to a target decreases as a communication environment increases in SNR. In particular, it may be confirmed that the RMSE of the distance estimation value greatly decreases in a communication environment with a high SNR. In addition, even in a communication environment with a low SNR, it may be confirmed that the RMSE of the distance estimation value decreases as compared with a theoretical range resolution (e.g., 3.9308 m) in an OFDM communication radar compatible system in the related art.

Accordingly, it may be confirmed that the communication module 100 (or the signal processing circuit 140) according to one or more embodiments may improve the distance estimation performance (e.g., resolution) of a communication radar compatible system, even in a communication environment with various SNRs.

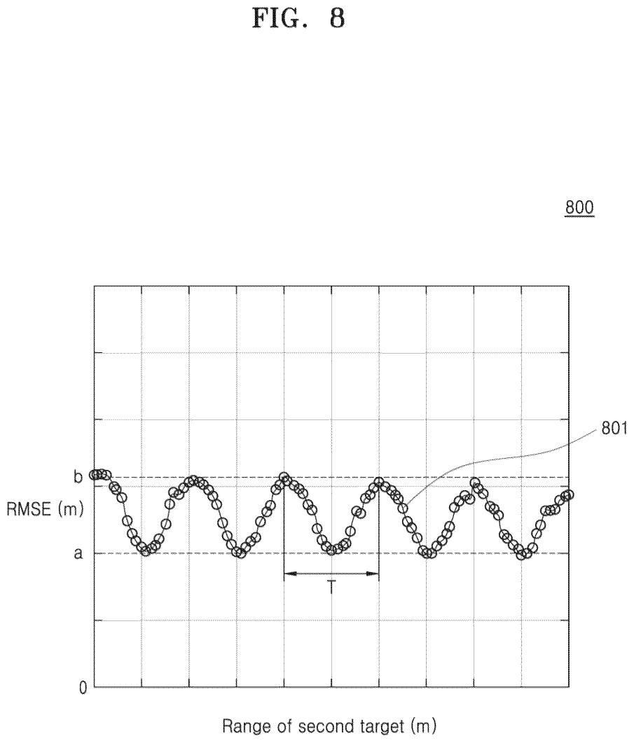

FIG. 8 is a diagram to describe a correlation between a change in distance to another target and a distance estimation error of a signal processing circuit, according to one or more embodiments.

The horizontal axis of a graph 800 of FIG. 8 may represent a distance (m) to a second target, and the vertical axis of the graph 800 of FIG. 8 may represent an RMSE of a distance estimation value to a target estimated by the signal processing circuit 140.

In the case of a communication radar compatible system in which a plurality of targets exist, a reception signal received by the communication module 100 may be in a form in which a plurality of target distance signals (e.g., a plurality of complex exponential signals) overlap each other In particular, as a target DFT spectrum of each target distance signal is in the form of a sine function with a plurality of sidelobes, the magnitude between different target distance signals may be affected. For example, when receiving a signal, the communication module 100 may receive an overlapping signal between a first target distance signal related to a distance to a first target and a second target distance signal related to a distance to a second target. Since each of a target DFT spectrum of the first target distance signal and a target DFT spectrum of the second target distance signal has a form of a sinc function with a plurality of sidelobes, the magnitudes of the sidelobes included in each target DFT spectrum may have a mutual influence (e.g., interference between the sidelobes).

Referring to FIG. 8, the graph 800 is a graph in which the RMSE of a distance estimation value to a first target is observed and recorded according to a change in distance to a second target by 0.2 m intervals within a predetermined second range (e.g., about 210 m to about 230 m) within a communication radar compatible system in which a plurality of targets (e.g., the first target, the second target, or the like) exist. Accordingly, in the communication radar compatible system in which the plurality of targets exist, a change in distance estimation error to the first target according to a change in distance to the second target (that is, a correlation between the change in distance to the second target and the distance estimation error to the first target) may be confirmed. When measuring the RMSE for the distance estimation value to the first target according to a change in distance to the second target (or a change in position of the second target) in FIG. 8, the distance to the first target is set to a random value within a predetermined first range (e.g., about 110 m to about 130 m), and the SNR is assumed to be set to 10 dB. A point 801 in the graph 800 may represent an average distance estimation error value (e.g., the RMSE for the distance estimation value to the first target) calculated by simulating a distance estimation value to the first target for a predetermined number of times (e.g., 10000 times) or more with respect to a particular distance to the second target.

As shown in FIG. 8, in the graph 800, it may be confirmed that the RMSE for the distance to the first target has a pattern that repeats with a period T (e.g., 4 m). This is because a distance between a theoretical range resolution of a communication radar compatible system signal is the same as a distance between sidelobes (null) of the second target distance signal. Here, the sidelobe (null) of the second target distance signal may mean a sample of which a sample magnitude value is ‘0’ within a target DFT spectrum of the second target distance signal. For example, when the position of the sidelobe (null) of the target DFT spectrum of the second target distance signal exists at a position of the peak frequency of the target DFT spectrum of the first target distance signal (that is, an interference occurring between the first target distance signal and the second target distance signal is minimum), the RMSE for the distance estimation value to the first target may be a (e.g., 0.1 m) (this is consistent with the result in FIG. 6A when the SNR is 10 dB). As another example, when the position of a sidelobe (kₚₑₐₖ) of the target DFT spectrum of the second target distance signal exists at a position of the peak frequency of the target DFT spectrum of the first target distance signal (that is, an interference occurring between the first target distance signal and the second target distance signal is maximum), the RMSE for the distance estimation value to the first target may be b (e.g., 0.15 m). However, it may be confirmed that the communication module 100 (or the signal processing circuit 140) according to one or more embodiments may estimate a distance to a target with an accuracy higher than the theoretical range resolution (e.g., 3.9308 m) of a communication radar compatible system, even in the case where the interference occurring between the first target distance signal and the second target distance signal is maximum.

FIG. 8 is shown for convenience of explanation, but in a communication radar compatible system in which a plurality of targets (e.g., a first target, a second target, or the like) exist, the RMSE of the distance estimation value to the first target estimated by the communication module 100 (or the signal processing circuit 140) may increase toward the decrease in distance between the communication module 100 and the second target.

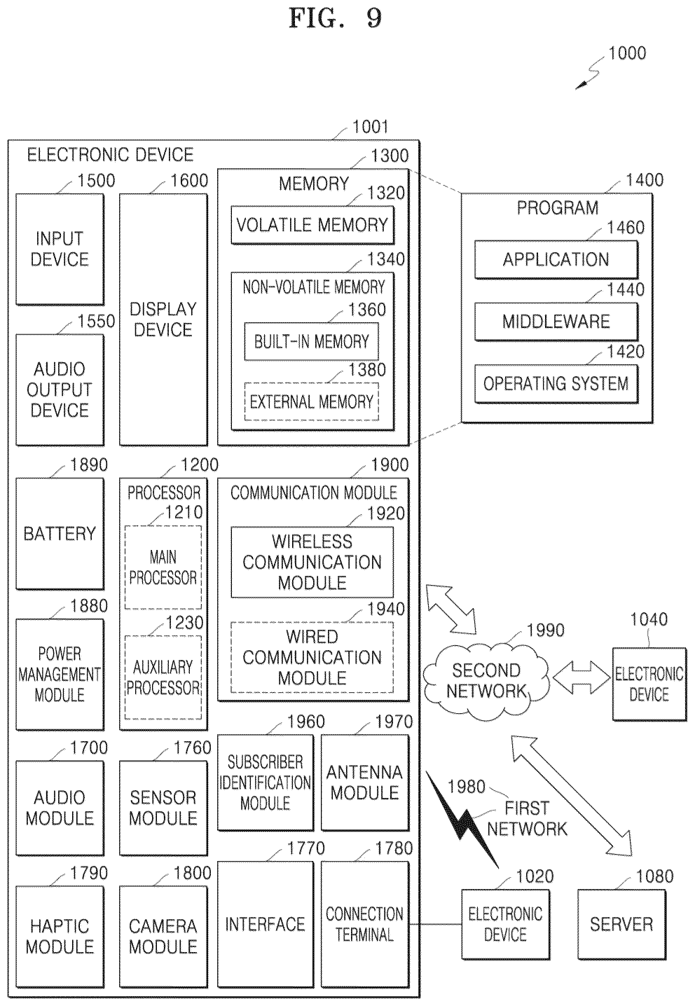

FIG. 9 is a block diagram of an electronic device according to one or more embodiments.

FIG. 9 is a block diagram of an electronic device 1001 within a network environment 1000, according to one or more embodiments. A communication module 1900 of FIG. 9 may correspond to the communication module 100 of FIGS. 1 to 8, and the electronic device 1001 of FIG. 9 may correspond to the electronic device 10 of FIGS. 1 to 8. The network environment 1000 of FIG. 9 may be a communication radar compatible environment (or a communication radar compatible system) using OFDM-based signals.

Referring to FIG. 9, in the network environment 1000, the electronic device 1001 may communicate with an electronic device 1020 through a first network 1980 (e.g., a near-field wireless communication network) or may communicate with an electronic device 1040 or a server 1080 through a second network 1990 (e.g., a long-range wireless communication network). According to one or more embodiments, the electronic device 1001 may communicate with the electronic device 1040 through the server 1080. According to one or more embodiments, the electronic device 1001 may include a processor 1200, a memory 1300, an input device 1500, an audio output device 1550, a display device 1600, an audio module 1700, a sensor module 1760, an interface 1770, a haptic module 1790, a camera module 1800, a power management module 1880, a battery 1890, the communication module 1900, a subscriber identification module 1960, or an antenna module 1970. In some embodiments, the electronic device 1001 may omit at least one of the above components (e.g., the display device 1600 or the camera module 1800), or may further include one or more other components. In some embodiments, some of the above components may be implemented as a single integrated circuit. For example, the sensor module 1760 (e.g., a fingerprint sensor, an iris sensor, or an illuminance sensor) may be implemented by being embedded in the display device 1600 (e.g., a display).

The processor 1200 may, for example, control at least one other component (e.g., a hardware or software component) of the electronic device 1001, which is connected to the processor 1200, by executing software (e.g., a program 1400), and may perform various data processing or computations. According to one or more embodiments, the processor 1200 may load instructions or data received from other components (e.g., the sensor module 1760 or the communication module 1900) into volatile memory 1320, process the instructions or data stored in the volatile memory 1320, and store result data in non-volatile memory 1340, as at least a portion of data processing or computations. According to one or more embodiments, the processor 1200 may include a main processor 1210 (e.g., a CPU or an application processor), and an auxiliary processor 1230 (e.g., a GPU, an image signal processor, a sensor hub processor, or a communication processor) that may operate independently or together with the main processor 1210. Additionally or alternatively, the auxiliary processor 1230 may be configured to use less power than the main processor 1210 or to be specialized for a given function. The auxiliary processor 1230 may be implemented separately from the main processor 1210 or as a portion of the main processor 1210.

The auxiliary processor 1230 may, for example, control at least a portion of functions or states associated with at least one of the components (e.g., the display device 1600, the sensor module 1760, or the communication module 1900) of the electronic device 1001 on behalf the main processor 1210 while the main processor 1210 is in an inactive (e.g., sleep) state or together with the main processor 1210 while the main processor 1210 is in an active (e.g., application execution) state. According to one or more embodiments, the auxiliary processor 1230 (e.g., an image signal processor or a communication processor) may be implemented as a portion of another functionally-related component (e.g., the camera module 1800 or the communication module 1900).

The processor 1200 according to one or more embodiments may control the communication module 1900 to estimate a frequency offset through signal processing and use the estimated frequency offset to correct a distance estimation value to at least one target.

The memory 1300 may store various pieces of data used by at least one component (e.g., the processor 1200 or the sensor module 1760) of the electronic device 1001. The data may include, for example, software (e.g., the program 1400) and input data or output data for commands associated with the software. The memory 1300 may include the volatile memory 1320 or the non-volatile memory 1340. The non-volatile memory 1340 may include built-in memory 1360 and external memory 1380.

The program 1400 may be stored as software in the memory 1300, and may include, for example, an operating system 1420, middleware 1440, or an application 1460.

The input device 1500 may receive commands or data to be used in a component (e.g., the processor 1200) of the electronic device 1001 from the outside (e.g., a user) of the electronic device 1001. The input device 1500 may include, for example, a microphone, a mouse, a keyboard, or a digital pen (e.g., a stylus pen).

The audio output device 1550 may output an audio signal to the outside of the electronic device 1001. The audio output device 1550 may include, for example, a speaker or a receiver. The speaker may be used for general purposes such as playing multimedia or playing recordings, and the receiver may be used for receiving incoming calls. According to one or more embodiments, the receiver may be implemented separately from the speaker or as a part of the speaker.

The display device 1600 may visually provide information to the outside (e.g., the user) of the electronic device 1001. The display device 1600 may include, for example, a display, a hologram device, or a projector, and a control circuit controlling the corresponding device. According to one or more embodiments, the display device 1600 may include a touch circuitry configured to sense a touch or a sensor circuitry (e.g., a pressure sensor) configured to measure the intensity of a force generated by a touch.

The audio module 1700 may convert sound into an electrical signal or an electrical signal into sound. According to one or more embodiments, the audio module 1700 may obtain sound through the input device 1500, or may output sound through the audio output device 1550 or an external electronic device (e.g., the electronic device 1020) (e.g., a speaker or a headphone) directly or wirelessly connected to the electronic device 1001.

The sensor module 1760 may sense an operating status (e.g., power or temperature) or an external environmental status (e.g., a user status) of the electronic device 1001 and generate an electrical signal or a data value corresponding to the sensed status. According to one or more embodiments, the sensor module 1760 may include, for example, a gesture sensor, a gyro sensor, a pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1770 may support at least one designated protocol that may be used to directly or wirelessly connect the electronic device 1001 to an external electronic device (e.g., the electronic device 1020). According to one or more embodiments, the interface 1770 may include, for example, a high definition multimedia interface (HDMI), a universal serial bus (USB) interface, a secure digital (SD) card interface, or an audio interface.

A connection terminal 1780 may include a connector through which the electronic device 1001 may be physically connected to an external electronic device (e.g., the electronic device 1020). According to one or more embodiments, the connection terminal 1780 may include, for example, a HDMI connector, a USB connector, an SD card connector, or an audio connector (e.g., a headphone connector).

The haptic module 1790 may convert an electrical signal into a mechanical stimulus (e.g., vibration or movement) or an electrical stimulus that a user may recognize through tactile or kinesthetic sensations. According to one or more embodiments, the haptic module 1790 may include, for example, a motor, a piezoelectric element, or an electrical stimulation device.

The camera module 1800 may capture still images and videos. According to one or more embodiments, the camera module 1800 may include at least one lens, image sensors, image signal processors, or flashes.

The power management module 1880 may manage power supplied to the electronic device 1001. According to one or more embodiments, the power management module 1880 may be implemented, for example, as at least a portion of a power management integrated circuit (PMIC).

The battery 1890 may supply power to at least one component of the electronic device 1001. According to one or more embodiments, the battery 1890 may include, for example, a non-rechargeable primary battery, a rechargeable secondary battery, or a fuel cell.

The communication module 1900 may support the establishment of a direct (e.g., wired) communication channel or a wireless communication channel between the electronic device 1001 and an external electronic device (e.g., the electronic device 1020, the electronic device 1040, or the server 1080) and the performance of communication through the established communication channel. The communication module 1900 may operate independently of the processor 1200 (e.g., an application processor) and may include at least one communication processor that supports direct (e.g., wired) communication or wireless communication. According to one or more embodiments, the communication module 1900 may include a wireless communication module 1920 (e.g., a cellular communication module, a near-field wireless communication module, or a GNSS communication module) or a wired communication module 1940 (e.g., a LAN communication module or a power line communication module). A communication module corresponding to any of these communication modules may communicate with the external electronic device 1040 through the first network 1980 (e.g., a near-field communication network such as Bluetooth, WiFi-direct, or IrDA) or the second network 1990 (e.g., a long-range communication network such as a cellular network, the Internet, or a computer network (e.g., LAN or WAN)). These different types of communication modules may be integrated into a single component (e.g., a single chip) or implemented as a plurality of separate components (e.g., a plurality of chips). The wireless communication module 1920 may identify and authenticate the electronic device 1001 within a communication network, such as the first network 1980 or the second network 1990, by using subscriber information (e.g., international mobile subscriber identity (IMSI)) stored in the subscriber identification module 1960.

The communication module 1900 according to one or more embodiments may include the signal processing circuit 140. The communication module 1900 may transmit a transmission signal to at least one target and receive an analog reception signal reflected from the at least one target to convert the received analog reception signal into a digital reception signal. The communication module 1900 may generate a target distance signal related to a distance to the at least one target based on the digital reception signal, estimate a frequency offset based on the target distance signal, and correct the distance estimation value to the at least one target by using the frequency offset.

To generate a target distance signal, the communication module 1900 according to one or more embodiments may estimate a transmission data symbol by applying DFT to the digital reception signal and generate the target distance signal based on a ratio between the estimated transmission data symbol and an actual transmission data symbol.

To estimate a frequency offset, the communication module 1900 according to one or more embodiments may generate a target DFT spectrum by applying DFT to the target distance signal, estimate a peak frequency within the target DFT spectrum, and estimate the frequency offset by using a ratio between a magnitude value of a DFT sample of the estimated peak frequency and a magnitude value of a DFT sample of a surrounding frequency.

To estimate the frequency offset by using the ratio between the magnitude value of the DFT sample of the estimated peak frequency and the magnitude value of the DFT sample of the surrounding frequency, the communication module 1900 according to one or more embodiments may identify a first DFT sample and a second DFT sample based on the estimated peak frequency within the target DFT spectrum, compare a magnitude value of the first DFT sample with a magnitude value of the second DFT sample, and, when the magnitude value of the first DFT sample is greater than the magnitude value of the second DFT sample, estimate the frequency offset based on a ratio between the magnitude value of the DFT sample of the estimated peak frequency and the magnitude value of the first DFT sample, and, when the magnitude value of the first DFT sample is less than the magnitude value of the second DFT sample, estimate the frequency offset based on a ratio between the magnitude value of the DFT sample of the estimated peak frequency and the magnitude value of the second DFT sample. Here, the first DFT sample may mean a DFT sample of a frequency before the estimated peak frequency among a plurality of frequencies that are continuously sampled, and the second DFT sample may mean a DFT sample of a frequency after the estimated peak frequency among the plurality of frequencies that are continuously sampled.

The antenna module 1970 may transmit signals or power to the outside (e.g., an external electronic device) or may receive signals or power from the outside. According to one or more embodiments, the antenna module 1970 may include an antenna including a radiator including a conductor or conductive pattern formed on a substrate (e.g., a printed circuit board (PCB)). According to one or more embodiments, the antenna module 1970 may include a plurality of antennas. In this case, at least one antenna suitable for a communication method used in a communication network, such as the first network 1980 or the second network 1990, may be selected, for example, from the plurality of antennas by the communication module 1900. Signals or power may be transmitted or received between the communication module 1900 and an external electronic device via the at least one selected antenna. According to some embodiments, other parts (e.g., a radio frequency integrated circuit (RFIC)) may be formed as a portion of the antenna module 1970, in addition to the radiator.

The antenna module 1970 according to one or more embodiments may transmit a transmission signal to at least one target and receive an analog reception signal reflected from the at least one target within a communication radar compatible system.

At least some of the above components may be connected to each other and exchange signals (e.g., commands or data) with each other via a communication method between peripheral devices (e.g., a bus, a general purpose input and output (GPIO), a serial peripheral interface (SPI), or a mobile industry processor interface (MIPI)).

According to one or more embodiments, commands or data may be transmitted or received between the electronic device 1001 and the external electronic device 1040 through the server 1080 connected to the second network 1990. Each of the external electronic devices 1020 and 1040 may be devices that are the same as the electronic device 1001 or different types from the electronic device 1001. According to one or more embodiments, all or a portion of operations executed by the electronic device 1001 may be executed in at least one of the external electronic devices (e.g., electronic devices 1020 and 1040, or the server 1080). For example, when the electronic device 1001 has to perform a function or service automatically or in response to a request from a user or another device, the electronic device 1001 may request at least one of the external electronic devices to perform at least a portion of the function or the service instead of or in addition to executing the function or service on its own. The at least one of the external electronic devices that has received the request may execute at least a portion of the requested function or service or an additional function or service related to the request, and may transmit a result of the execution to the electronic device 1001. The electronic device 1001 may provide the original result or may additionally process the result and provide the processed result as at least a portion of a response of the request. To this end, for example, cloud computing, distributed computing, or client-server computing technology may be used.

While the disclosure has been particularly shown and described with reference to embodiments thereof, it will be understood that various changes in form and details may be made therein without departing from the spirit and scope of the following claims.

What is claimed is:

1. An operating method of a communication module in a communication radar compatible system, the operating method comprising:
transmitting, via a plurality of antennas, a transmission signal to at least one target;
receiving, via the plurality of antennas, an analog reception signal reflected from the at least one target;
converting the analog reception signal into a digital reception signal;
generating a target distance signal related to a distance to the at least one target based on the digital reception signal;
estimating a frequency offset based on the target distance signal;
correcting a distance estimation value to the at least one target based on the frequency offset; and
outputting the corrected distance estimation value.

2. The operating method of claim 1, wherein the generating the target distance signal based on the digital reception signal comprises:
estimating a transmission data symbol by applying discrete Fourier transform (DFT) to the digital reception signal; and
generating the target distance signal based on a ratio between the estimated transmission data symbol and an actual transmission data symbol.

3. The operating method of claim 1, wherein the estimating the frequency offset comprises:
generating a target discrete Fourier transform (DFT) spectrum by applying DFT to the target distance signal;
estimating a peak frequency within the target DFT spectrum; and
estimating the frequency offset based on a ratio between a magnitude value of a discrete Fourier transform (DFT) sample of the estimated peak frequency and a magnitude value of a DFT sample of a surrounding frequency.

4. The operating method of claim 3, wherein the estimating the frequency offset based on the ratio between the magnitude value of the DFT sample of the estimated peak frequency and the magnitude value of the DFT sample of the surrounding frequency comprises:
identifying a first DFT sample and a second DFT sample based on the estimated peak frequency within the target DFT spectrum;
comparing a magnitude value of the first DFT sample with a magnitude value of the second DFT sample; and
estimating the frequency offset based on a result of the comparing.

5. The operating method of claim 4, wherein the first DFT sample is of a frequency lower than the estimated peak frequency among a plurality of frequencies that are continuously sampled, and
wherein the second DFT sample is of a frequency higher than the estimated peak frequency among the plurality of frequencies that are continuously sampled.

6. The operating method of claim 4, wherein the estimating the frequency offset based of the result of the comparing further comprises, based on the magnitude value of the first DFT sample being greater than the magnitude value of the second DFT sample, estimating a first frequency offset based on a ratio between the magnitude value of the DFT sample of the estimated peak frequency and the magnitude value of the first DFT sample, and
wherein the correcting the distance estimation value to the at least one target comprises correcting the distance estimation value based on the first frequency offset.

7. The operating method of claim 4,
wherein the estimating of the frequency offset based of the result of the comparing comprises, based on the magnitude value of the first DFT sample being less than the magnitude value of the second DFT sample, estimating a second frequency offset based on a ratio between the magnitude value of the DFT sample of the estimated peak frequency and the magnitude value of the second DFT sample, and
wherein the correcting of the distance estimation value to the at least one target comprises correcting the distance estimation value based on the second frequency offset.

8. The operating method of claim 1, wherein the communication radar compatible system uses an orthogonal frequency division multiplexing (OFDM)-based signal.

9. A communication module of a communication radar compatible system, the communication module comprising:
a plurality of antennas configured to transmit a transmission signal to at least one target and receive an analog reception signal reflected from the at least one target; and
a signal processing circuit configured to:
sample and convert the analog reception signal into a digital reception signal,
generate a target distance signal related to a distance to the at least one target based on the digital reception signal,
estimate a frequency offset based on the target distance signal,
correct a distance estimation value to the at least one target based on the frequency offset; and
output the corrected distance estimation value.

10. The communication module of claim 9, wherein, to generate the target distance signal, the signal processing circuit is further configured to:
estimate a transmission data symbol by applying discrete Fourier transform (DFT) to the digital reception signal, and
generate the target distance signal based on a ratio between the estimated transmission data symbol and an actual transmission data symbol.

11. The communication module of claim 9, wherein, to estimate the frequency offset, the signal processing circuit is further configured to:
generate a target discrete Fourier transform (DFT) spectrum by applying DFT to the target distance signal,
estimate a peak frequency within the target DFT spectrum, and
estimate the frequency offset based on a ratio between a magnitude value of a DFT sample of the estimated peak frequency and a magnitude value of a DFT sample of a surrounding frequency.

12. The communication module of claim 11, wherein, to estimate the frequency offset based on the ratio between the magnitude value of the DFT sample of the estimated peak frequency and the magnitude value of the DFT sample of the surrounding frequency, the signal processing circuit is further configured to:
identify a first DFT sample and a second DFT sample based on the estimated peak frequency within the target DFT spectrum,
compare a magnitude value of the first DFT sample with a magnitude value of the second DFT sample, and
estimate the frequency offset based on a result of the comparing.

13. The communication module of claim 12, wherein the first DFT sample is of a frequency lower than the estimated peak frequency among a plurality of frequencies that are continuously sampled, and
wherein the second DFT sample is of a frequency higher than the estimated peak frequency among the plurality of frequencies that are continuously sampled.

14. The communication module of claim 12, wherein, to estimate the frequency offset based on the result of the comparing, the signal processing circuit is further configured to, based on the magnitude value of the first DFT sample being greater than the magnitude value of the second DFT sample, estimate a first frequency offset based on a ratio between the magnitude value of the DFT sample of the estimated peak frequency and the magnitude value of the first DFT sample, and,
wherein the signal processing circuit is further configured to correct the distance estimation value based on the first frequency offset.

15. The communication module of claim 12, wherein, to estimate the frequency offset based on the result of the comparing, the signal processing circuit is further configured to, based on the magnitude value of the first DFT sample being less than the magnitude value of the second DFT sample, estimate a second frequency offset based on a ratio between the magnitude value of the DFT sample of the estimated peak frequency and the magnitude value of the second DFT sample, and,
wherein the signal processing circuit is further configured to correct the distance estimation value based on the second frequency offset.

16. The communication module of claim 9, wherein the communication radar compatible system uses an orthogonal frequency division multiplexing (OFDM)-based signal.

17. An electronic device of a communication radar compatible system, the electronic device comprising:
a communication module;
memory storing instructions; and
at least one processor operatively connected to the communication module and the memory, and configured to execute the instructions,
wherein the instructions, when executed by the at least one processor, cause the at least one processor to control the communication module to:
transmit a transmission signal to at least one target;
receive an analog reception signal reflected from the at least one target and convert the analog reception signal into a digital reception signal;
generate a target distance signal related to a distance to the at least one target based on the digital reception signal;
estimate a frequency offset based on the target distance signal;
correct a distance estimation value to the at least one target based on the frequency offset; and
output the corrected distance estimation value.

18. The electronic device of claim 17, wherein the instructions, when executed by the at least one processor, cause the at least one processor to control the communication module to generate the target distance signal by:
estimating a transmission data symbol by applying discrete Fourier transform (DFT) to the digital reception signal, and
generating the target distance signal based on a ratio between the estimated transmission data symbol and an actual transmission data symbol.

19. The electronic device of claim 17, wherein the instructions, when executed by the at least one processor, cause the at least one processor to control the communication module to estimate the frequency offset by:
generating a target discrete Fourier transform (DFT) spectrum by applying DFT to the target distance signal,
estimating a peak frequency within the target DFT spectrum; and
estimate the frequency offset based on a ratio between a magnitude value of a DFT sample of the estimated peak frequency and a magnitude value of a DFT sample of a surrounding frequency.

20. The electronic device of claim 19, wherein the instructions, when executed by the at least one processor, cause the at least one processor to control the communication module to estimate the frequency offset based on the ratio between the magnitude value of the DFT sample of the estimated peak frequency and the magnitude value of the DFT sample of the surrounding frequency by:
identifying a first DFT sample and a second DFT sample based on the estimated peak frequency within the target DFT spectrum;
comparing a magnitude value of the first DFT sample with a magnitude value of the second DFT sample;
based on the magnitude value of the first DFT sample being greater than the magnitude value of the second DFT sample, estimating the frequency offset based on a ratio between the magnitude value of the DFT sample of the estimated peak frequency and the magnitude value of the first DFT sample; and
based on the magnitude value of the first DFT sample being less than the magnitude value of the second DFT sample, estimating the frequency offset based on a ratio between the magnitude value of the DFT sample of the estimated peak frequency and the magnitude value of the second DFT sample.
